(19) United States
(12) Patent Application Publication
(10) Pub. No.: US 2008/0184241 A1
(43) Pub. Date: Jul. 31, 2008

(54) Techniques for automated balancing of tasks across multiple computers

(75) Inventors: Todd R. Headrick, Redmond, WA (US); James C. Gray, Redmond, WA (US); Lee Linden, Redmond, WA (US); James M. Lyon, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/699,596

(22) Filed: Jan. 30, 2007

(51) Int. Cl. G06F 9/46

(52) U.S. Cl. 718/102

(57) ABSTRACT

Techniques are provided for determining a schedule for performing tasks. Each of the tasks to be scheduled is registered. The schedule includes tasks to be performed for a plurality of devices using at least one shared resource. The schedule is determined for performing the tasks in accordance with resources used by each of the tasks and in accordance with usage patterns of the plurality of devices. An inquiry is made as to whether to commence performance of a task at an associated scheduled time in accordance with the schedule. A scheduler determines whether one or more resources used by said task are available. If the determining step determines that the one or more resources are not available, rescheduling the task to be performed at another time.

### BACKGROUND

Existing computer systems may include one or more computers, such as personal computers, connected to a server via a network. Each of the one or more computers may have tasks to perform which utilize resources. One or more of the resources used in connection with performing each task may also be shared among the various tasks and computers. Each of the computers may include a schedule indicating when to perform various tasks for the computer independent of scheduled tasks of other components in the computer system. When two or more of the computers are each scheduled to perform a task which involves using one or more shared resources, there may be performance issues if the two or more computers contend for the same shared resource at the same time. The foregoing may cause performance issues for the two or more computers each trying to complete a scheduled task as well for other computers and components utilizing the shared resource.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are provided for determining a schedule for performing tasks on one or more devices, such as computers, connected to a server. The usage patterns of each device may be tracked. The schedule may take into account the usage patterns and resources utilized by the scheduled tasks to reduce resource conflicts. The schedule may be automatically adapted to changes in observed usage patterns. Prior to performing a task at its scheduled time, an inquiry may be to whether to commence performance of the task. If the one or more resources used by the task are available, the task may be performed. Otherwise, the task may be rescheduled for performance at another time. Tasks to be scheduled may be registered using an application programming interface.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a device for use in connection with performing the techniques described herein;

FIG. 3 is an example of components that may be included in an embodiment of a server for use in connection with performing the techniques described herein;

FIG. 4 is an example illustrating data flow in one embodiment connection with a schedule; and

FIGS. 5 and 6 are flowcharts of processing steps that may be performed in an embodiment utilizing the techniques herein for scheduling.

### DETAILED DESCRIPTION

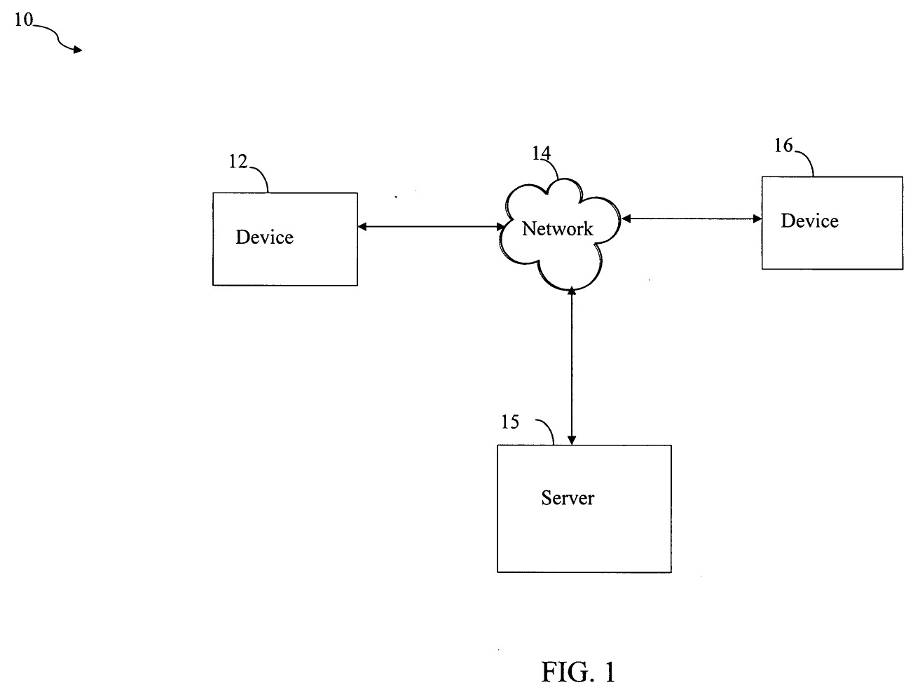

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein in connection with balancing tasks performed on multiple computers or other devices connected to the network. Techniques are described herein that may be used in connection with scheduling tasks performed on each of the devices, such as computers, in which the tasks may utilize one or more shared resources. The tasks may include maintenance tasks such as, for example, incremental and full backup operations of the computers to the server, performing software updates stored on or utilizing the server and network, and the like. Performance issues may exist if two or more tasks execute at the same time requiring use of a same shared resource. Shared resources may include, for example, the network, components of the server such as the server processor, a server drive, and a resource (e.g., such as a system disk) local to a device connected to the server in which the resource may be used by more than one scheduled task (e.g., virus scanning of the system disk, defragmentation of the system disk). The performance issues may exist for the two tasks utilizing the shared resource. For example, the techniques herein may be used in connection with scheduling tasks amongst two or more computers, two tasks on the same computer or other device, as well as other tasks performed on the server, such as server maintenance tasks including virus scanning of a server device, and the like.

Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are devices 12 and 16, a network 14, and a server 15. The devices 12 and 16 may be, for example, a computer, such as a personal or desk top computer, having a display output device and an input device providing for interactive I/O with a user thereof. In following paragraphs, additional details are provided with respect to the device 12. However, the same details may also apply to device 16 as well as one or more other devices that may be connected to the network 14 in an embodiment. Although the example 10 of FIG. 1 includes only 2 devices and a single server, an embodiment utilizing the techniques herein may include any number of devices and other components.

The device 12 included in FIG. 1 is exemplary for purposes of illustrating the techniques described herein in connection with scheduling techniques herein. In one embodiment, any device 12 providing the functionality described herein may be included in an embodiment. The device 12 may include a processor used to execute code included in one or more program modules. Described in more detail elsewhere herein are program modules that may be executed by the device 12 in connection with the techniques described herein. The device 12 may operate in a networked environment and communicate with the server 15 and other computers or components not shown in FIG. 1. As described herein, the device 12 may be a personal computer. In other embodiments, the functionality of device 12, or the device 12 itself, may be included in another component in accordance with a particular environment in which the device 12 is utilized.

The server 15 may communicate with devices 12 and 16 when connected to the network 14. The server 15 may include one or more applications and associated data for use in connection with communications to device 12. For example, the server 15 may host a server portion of an electronic calendar and messaging program, a backup utility for backing up data from the device 12 to the server, and other applications. The device 12 may include a client-side application for use with the electronic calendar and messaging program, backup utility and the like. When the device 12 is connected to the server 15, the device 12 communicates with the respective server-side application and may also utilize data stored at the server 15.

It will be appreciated by those skilled in the art that although the device 12 is shown in the example as communicating in a networked environment, the device 12 may communicate with other components utilizing different communication mediums. For example, the device 12 may communicate with one or more components utilizing a network connection, and/or other type of link known in the art including, but not limited to, the Internet, an intranet, or other wireless and/or hardwired connection(s) to the server 15 and/or other components, such as the device 16.

It should also be noted that although each of the devices 12 and 16 are illustrated as having network connectivity to the server 15, the techniques described herein may be used in connection with a device directly connected to the server 15 without a network.

As will also be appreciated by those skilled in the art, the techniques herein may be used in connection with scheduling any one or more different types of tasks performed on each of the computers or other devices as well as tasks performed on the server. The techniques herein may be used in connection with scheduling such tasks to reduce resource contention and reduce adverse performance effects amongst the devices, server and other components. The techniques described herein may be used, for example, to schedule tasks performed by the devices 12 and 16 which may utilize shared resources, such as those of the server and/or network. Such tasks may include backup operations to backup data from the devices to the server, performing software updates on the devices which utilize resources local to the device, resources of the server and/or network, and the like. The scheduling may include those tasks scheduled for performance by each of the devices, such as computers, as well as tasks performed by the server, such as virus scanning, defragmentation or disk repair of a server disk or other storage device. The techniques herein may also prioritize task performance to give priority to interactive tasks performed when a user is logged onto one of the devices, or when the user is otherwise likely to log onto the device. The latter may be determined in accordance with monitoring and observing for a period of time as to when a user actually is logged onto a device. As an example use of the techniques herein, certain tasks for a computer, such as daily incremental backup operations, may not be scheduled during a time period when a user is typically logged into the computer. If the user typically logs on to the computer and works during specified daytime hours, the scheduling techniques may take this into account and schedule daily incremental backup operations to occur at another time, such as during evening hours. In the event a user logs in during the evening hours, a scheduled task may be postponed or rescheduled to give the interactive task of the logged-in user a higher priority. An embodiment may also utilize one or more techniques to ensure that a scheduled task which needs to be performed is performed within certain specified criteria, such as, for example, to ensure that incremental backups occur at least once within a 48 hour time period, critical software updates and virus scans are performed within a specified time period, and the like.

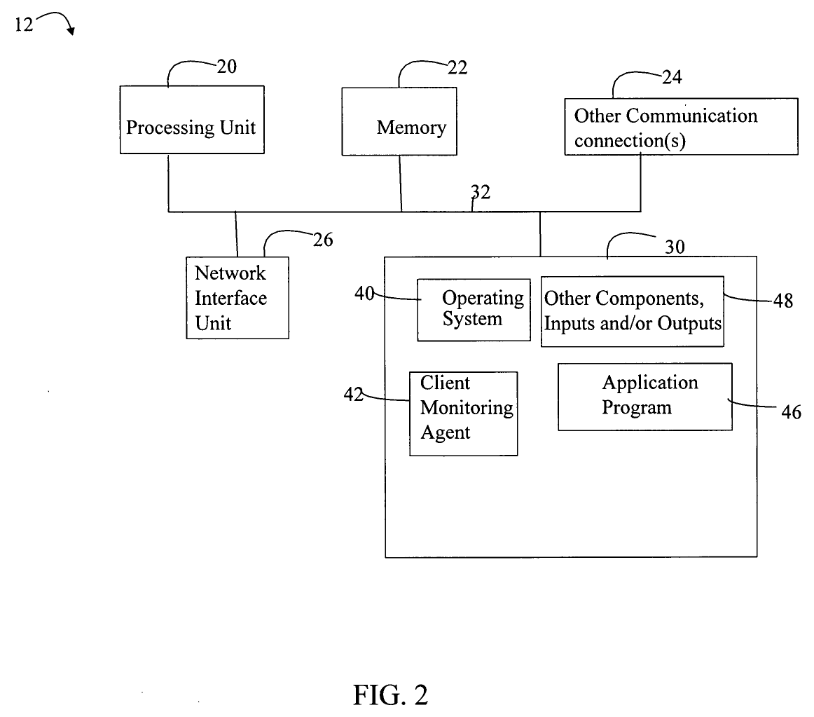

As will also be described herein, an embodiment may track usage patterns associated with each of the devices in connection with scheduling tasks performed across the multiple devices and/or the server. As such, an embodiment may learn the various patterns and usages associated with each device and its users over time. The schedule may be automatically adjusted as such patterns change and/or are learned through monitoring and logging activity of the device. The techniques herein provide for automatically adapting to changes in usage patterns over time in accordance with the observed collected data. Referring now to FIG. 2, shown is an example of components that may be included in the device 12 as may be used in connection with performing the various embodiments of the techniques described herein. The device 12 may include one or more processing units 20, memory 22, a network interface unit 26, storage 30, one or more other communication connections 24, and a system bus 32 used to facilitate communications between the components of the device 12.

Depending on the configuration and type of user device 12, memory 22 may be volatile (such as RAM), non-volatile (such as ROM, flash memory, etc.) or some combination of the two. Additionally, the device 12 may also have additional features/functionality. For example, the device 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the device 12. The storage 30 in one embodiment may be a mass-storage device with associated computer-readable media providing non-volatile storage for the device 12. Although the description of computer-readable media as illustrated in this example may refer to a mass storage device, such as a hard disk or CD-ROM drive, it will be appreciated by those skilled in the art that the computer-readable media can be any available media that can be accessed by the device 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by device 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The device 12 may also contain communications connection(s) 24 that allow the computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the device 12 may operate in a networked environment as illustrated in FIG. 1 using logical connections to remote computers through a network. The device 12 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the device 12, one or more of these elements included in the storage 30 may also reside in a portion of memory 22, such as, for example, RAM for controlling the operation of the user computer 12. The example of FIG. 2 illustrates various components including an operating system 40, one or more application programs 46, a client monitoring agent 42, and other components, inputs, and/or outputs 48. In one embodiment, the application program 46 may be a web browser, a client-side application, or other application used when operating the device 12 standalone and/or with external connectivity.

The operating system 40 may be any one of a variety of commercially available or proprietary operating systems. The operating system 40, for example, may be loaded into memory in connection with controlling operation of the user computer. One or more application programs 46 may execute in the device 12 in connection with performing user tasks and operations;

The client monitoring agent 42 may collect usage data about the device 12 and tasks performed thereon, and then report such data to the server 15. For example, the agent 42 may collect information regarding when a user is logged on to the device 12, what particular tasks are performed by the user when logged on/not logged on, how long each task is performed, what resource(s) are used, and the like. Besides collecting information related to interactive usage, the agent 42 may also collect information regarding other tasks performed by the device 12 depending on the particular device. For example, the device 12 may be a personal computer and different maintenance tasks may be performed by the personal computer including, for example, incremental and full backup operations, software updates, system disk operations such as virus scanning, defragmentation and repair operations, and the like. Different maintenance tasks may utilize resources only of the personal computer (e.g., local to the computer), or may also utilize other resources (e.g., non-local to the computer) such as those of the network and/or server. Information regarding the task, resource usage, amount of time to complete the task, and the like, may be collected by the agent 42 and forwarded to the server for use in connection with the scheduling techniques herein.

As will be appreciated by those skilled in the art, the data collected by the agent 42 may be reported to the server 15 using any one or more techniques. For example, in one embodiment, the agent 42 may report collected data at predetermined time periods. The agent 42 may also report data to the server 15 in response to periodic polling by the server 15. In the event a user logs onto the device 12, the agent 42 may report such interactive activity immediately to the server 15. In one embodiment in which interactive login activity is given the highest priority and may displace or cause rescheduling of a scheduled task, the agent 42 may immediately report any interactive logon activity to the server 15. The server 15 may then make any possible adjustments to a scheduled task. It should be noted that if a scheduled task is already in progress, it may not be possible to interrupt execution of the task. Alternatively, if the user is logged on and the scheduled task has not yet commenced, the scheduled task may be rescheduled.

As described above, the device 16 and other devices may include components similar to those as described in connection with FIG. 2. Additionally, the devices may include other components for the particular device and usage thereof. In one embodiment as described herein, each of the devices 12 and 16 may be computers such as personal computers. However, the foregoing should not be construed as a limitation of the techniques herein which, as will be appreciated by those skilled in the art, may be utilized with a wide variety of devices capable of performing the processing described herein.

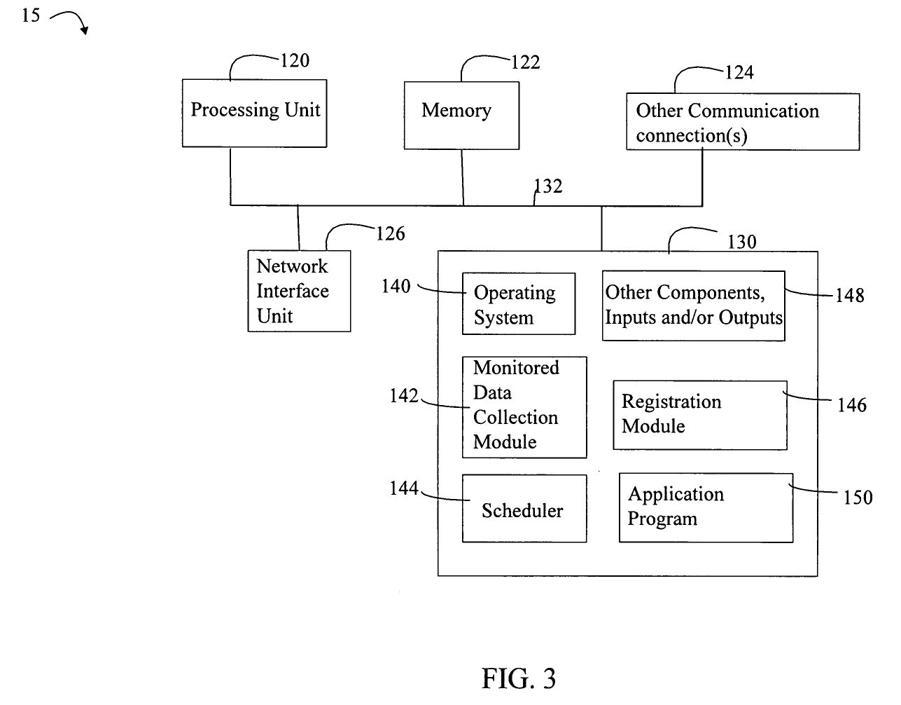

Referring now to FIG. 3, shown is an example of components that may be included in the server 15 and used in connection with performing the various embodiments of the techniques described herein. As illustrated in FIG. 3, an embodiment of the server 15 may include components similar to those described in connection with FIG. 2. In one embodiment the server 15 may include one or more operating systems 140, a monitored data collection module 142, a scheduler 144 and a registration module 146.

The registration module 146 may be used in connection with registering tasks of the one or more devices 12 and 16 for scheduling by the scheduler 144. The registration may be performed using an API (application programming interface) including one or more parameters. In one embodiment, the API may include the following:

task, duration, priority, scheduling criteria

where “task” identifies the task being registered for scheduling, “duration” identifies the expected duration or time it takes to perform the task, “priority” identifies a scheduling priority associated with scheduling the task, and “scheduling criteria” identifies one or more criteria for use in connection with scheduling the task for execution. In an embodiment, one or more of the foregoing parameters may be optional and assigned default values if not specified using the API. For example, in one embodiment, the task parameter may be required and the remaining parameters indicated above may be optionally specified in connection with registering a task. Depending on the particular task, a default value may be assigned by the registration module 146. The priority parameter may indicate a relative priority with respect to other registered task. The priority parameter may identify one priority of a defined priority classification used by the scheduler 144. For example, in one embodiment, a priority classification may be defined which includes 3 priority classes, 1 indicating the highest priority and 3 indicating the lowest priority. An embodiment may allow a user to redefine the priority classification or define additional priority classes besides the foregoing 3 priority classes. If no priority is specified, a default of “2” may be assigned to a task. The scheduling criteria may include other criteria used by the scheduler. Such scheduling criteria may include, for example, a specified time period indicating that the task should be performed at least once during the time period. For example, incremental backups may be performed at least once every 48 hours, a full backup may be performed once a week, and the like. If the task is for performing software updates for a device, the scheduling criteria may indicate that an update classified as critical, related to security, and the like, should be performed within 24 hours of the update becoming available or known to the server. If the update is other than the foregoing, then the update should be performed within another specified time period. In the event that the specified time period passes and the scheduled task is not performed, processing may be performed to facilitate completion of the task. For example, the priority associated with the task may be incremented if possible. The task may be performed ahead of all other scheduled tasks of the same priority by effectively or actually increasing the task's priority. The scheduling criteria may thus affect or vary the priority in accordance with an aging of an unperformed scheduled task. The scheduling criteria may also indicate times when the task should be scheduled. For example, backup operations may be performed during evening, weekend or other non-peak hours that may vary with each computer or other device 12 for which tasks are being scheduled. The registration module 146 may be used to register each task for each computer or other device 12,16. Additionally, an embodiment may use the registration module 146 to register server tasks to also be considered in connection with the scheduling techniques herein. In one embodiment, the tasks that may be registered for each device, such as a personal computer, may include: incremental and/or full backup of device data to the server, software update operations to update the operating system or other software on the device using the server to provide such updates, and performing operations on a local drive, disk, storage device, and the like, of the device. Such operations may include performing a disk repair, virus scan, defragmentation or other operation of a drive local to the device 12. The tasks scheduled for each device 12 may utilize resources local to the device 12 and/or non-local resources with respect to the device 12 (e.g., those of the network and/or server). In one embodiment, server tasks that may be registered include applying software updates to the server, and performing operations on a drive, such as the system disk, of the server. Such operations may include those as also performed on a drive local to the device 12.

In one embodiment as described elsewhere herein, interactive login activity may be automatically assigned a highest priority. Tasks initiated or performed interactively when a user is logged into a device may be given such priority without being registered in one embodiment using the techniques herein.

The monitored data collection module 142 facilitates collection of the monitored data reported by each of the agents 42 on each device 12, 16. The module 142 may utilize data collected over a time period to determine an average amount of time it takes to complete a task on each device 12. The module 142 may also track usage of each computer or other device 12, 16 over time with respect to interactive logins, tasks performed, the resources used by each task, and the like. In one embodiment, the scheduler 144 may use the foregoing and other information in determining and updating a schedule.

As described elsewhere herein, a task may be registered for scheduling in which the task is performed on the server and/or a device. In an embodiment in which server tasks may be registered for scheduling, the server 15 may also include a monitoring agent similar to agent 42 of FIG. 2 in which the monitoring agent monitors and reports on activities related to scheduled server tasks, resources utilized, and the like as described elsewhere herein. In other words, for each task that can be scheduled, an embodiment may also include functionality for observing and monitoring activity related to performance of each task. Additionally, for the devices, reporting may be performed regarding user login or interactive usage. The monitoring data collected by the foregoing agents is reported to the module 142 in one embodiment as described herein.

In connection with techniques herein, the task registration information collected by the registration module 146 and the monitored data collected by the module 142 may be used by the scheduler 144 to determine and update a schedule. The scheduler may determine an initial schedule in accordance with information obtained during task registration. For example, in one embodiment in which only a priority and initial duration time are provided for each task, the scheduler may schedule those tasks of a higher priority to be performed prior to other tasks of a lower priority. If there are multiple tasks of a same priority, the scheduler may utilize other criteria to determine an ordering of the multiple tasks having the same priority. For example, the scheduler may schedule a first task prior to another task of the same priority level if the first task was registered prior to the other task. As another example, the scheduler may schedule the first task prior to another task of the same priority if the first task is expected to complete prior to the other task. It should be noted that an embodiment may also have a different priority associated with each task to be scheduled.

In connection with the foregoing, the scheduler 144 may utilize information collected by the registration module to determine an initial schedule. The schedule may be updated over time as additional observed information is collected and reported by each device, for example, using the device agents 42 and the module 142.

The server 15 may also include one or more applications 150, such as client-side applications, which may be accessed and executed when device 12 is connected to the server 15. The application 150 may perform, for example, a service such as a backup service or operation, software update, and the like, for a user of a connected device 12.

Once an initial schedule is determined, an embodiment may utilize any one of a variety of different techniques in connection with notifying each device 12, 16 as to the scheduled times for each of its registered tasks. In one embodiment, the scheduler 144 notifies each device 12 regarding the scheduled time for each of its registered tasks. If there is an update to the scheduled time, the scheduler 144 informs the device 12 regarding the updated scheduled time. When the scheduled time arrives, the device 12 may contact the server 15 and inquire as to whether the device 12 may perform its scheduled task. In response, the scheduler 144 may determine that the device 12 may perform its scheduled task, for example, if the one or more resources needed to perform the task are available for use. The scheduler 144 may alternatively determine that a device 12 may not be able to perform its scheduled task, for example, if a resource needed by the device 12 to perform the task is currently in use or otherwise unavailable for the device 12. The foregoing may occur, for example, if a currently executing task of another device 16 has taken longer to complete than as scheduled. In response, the scheduler 144 may reschedule the task for device 12 and accordingly notify the device 12 regarding the rescheduled time.

The scheduler 144 may utilize any one of a variety of different rescheduling techniques. For example, the task may be rescheduled at the first available time slot when the task is expected to complete. The first available time slot may be the first available time at which no other task is scheduled. The first available time slot may also be the first available time which displaces a scheduled task of a lesser priority but does not displace a scheduled task of a higher priority. The foregoing rescheduling may include updating the schedule maintained by the scheduler 144 on the server 15. As described herein, the schedule includes a schedule of tasks to be performed by one or more devices connected to the server 15.

In the foregoing example, each of the devices 12 may initiate performance of its scheduled tasks when the scheduled times arrive. As described above, each device may track when one of its scheduled task times occurs and request permission of the server 15 to commence processing of the scheduled task. Alternatively, an embodiment may have the server 15 notify each device when one of its scheduled task times occurs and the device has permission to perform the scheduled task (e.g., when the necessary resources are available as may be determined by the server).

In connection with determining a schedule, the scheduler 144 may also consider the resources utilized by a registered task. The scheduler may determine a schedule in accordance with goals of minimizing contention of resources which are shared among tasks of a same device or among different devices 12,16. Such resources may be local to a device (e.g., the system disk of the device 12) and may also be non-local to a device (e.g., network resources, server resources). For example, in connection with performing a software update or backup operation, the scheduler 144 may schedule only a single device 12 or 16 connected to the server 15 via the network 14 to perform such a task since each of these particular tasks utilize the same server resources and the network. Such operations may consume a large amount of network bandwidth and server resources that two such operations may be scheduled for performance serially (e.g., are not performed at the same time). If two such operations are performed at the same time, the network bandwidth may be saturated and the server performance may degrade. Thus, the scheduler may determine an initial schedule which staggers without overlap performing such operations. In connection with determining the schedule, the scheduler 144 may also consider what device-local resources are used for a scheduled task. For example, performing an operating system update operation for a device 12 may use the server and network and the scheduler may not schedule an update or backup operation for another device at the same time due to the resources and amount thereof consumed for performing such tasks. The device 12 may also have a registered task for performing a virus scan or defragmentation of its local system disk. Although the virus scan or defragmentation of the device's system disk may not utilize the network or server resources, both the system update operation and the virus scan or defragmentation of the local system disk may utilize a same resource of the device 12. For example, the virus scan of the local system disk of device 12 may be accessing the system disk at the same time the system update operation processing commences rebooting the device 12. The foregoing is not desirable and may cause the scheduled tasks to fail should they occur. As such, the scheduler may also consider utilization of resources local to the device 12 as well as those which are non-local with respect to the device 12 when scheduling the tasks.

As described herein, the monitored data collection module 142 of the server 15 may collect data regarding how long it takes a scheduled task to complete. Such information may be used to automatically update or revise a schedule. For example, initial registration information may indicate that each incremental backup for devices 12 and 16 take 1 hour to complete. Data collected over the next several weeks or other time period indicates that device 12's incremental backups actually take 1½ hours and device 16's incremental backups actually take ½ hour to complete. The foregoing task duration time may be determined as an average over a time period. As such, the scheduler 144 may utilize the observed or actual data to determine an updated task duration time and accordingly revise the schedule. For example, if an incremental backup for device 12 is scheduled daily at 1 a.m. and an incremental backup for device 16 is scheduled at 2 a.m., the schedule may be revised to start the incremental backup for device 16 at 2:30 a.m. In the event that the usage of a device changes over time so that the time to complete the incremental backup or other task changes, the module 142 may detect such changes over time by a revised average task duration time. The scheduler 144 may obtain such changes from module 142 at predetermined time periods. In connection with the foregoing the scheduler 144 may query or poll the module 142 at different times. Alternatively, the module 142 may report to the scheduler 144 at different times. The module 142 may also report updated observed information to the scheduler 144 when a monitored duration time or other value has changed by a specified amount. In one embodiment, the threshold reporting limits may be specified so that, for example, if a monitored average duration time for a task changes by a specified amount, the module 142 notifies the scheduler 144 of this change allowing the scheduler 144 to revise the schedule.

In one embodiment, the scheduler 144 may allow only a single task to utilize a resource at a time so that two tasks are not scheduled for performance at the same time if the two tasks utilize a same resource. In other words, the scheduler does not allow performance of two tasks to overlap if they use a same resource. In another embodiment, the scheduler 144 may schedule tasks to overlap if they use a same resource in accordance with an amount of resource consumed by each task. For example, the network may have a specified maximum bandwidth. A first task and a second task may be scheduled for performance at the same time if the amount of collective bandwidth utilized by the first and second tasks does not exceed the maximum bandwidth or some other threshold bandwidth. Similarly, other tasks may be scheduled in accordance with an amount of a particular resource used by each task.

The module 142 as described herein may also collect information regarding when a user is logged on to a device. The foregoing may be used to determine non-peak or off hours when each device is not being utilized for interactive tasks. During such non-peak or off hours, maintenance or other tasks for each device may be scheduled. If such usage patterns change over time, the module 142 will detect such patterns regarding interactive usage and login, and report the foregoing to the scheduler. For example, a device 12 may be used by a first employee who works during the day (e.g., 9 a.m.-5 p.m.). At a later point in time, the first employee changes shifts and works the “graveyard” shift (e.g., 11 p.m.-7 a.m.). As such, backup operations for the device may be initially scheduled for 1 a.m. When the employee changes to the graveyard shift, the scheduler may reschedule the backup operations to be performed at a time other than 11 p.m.-7 a.m. The scheduler 144 may determine that the user is logged on at 1 a.m. when the backup operation is scheduled. When 1 a.m. arrives, the device 12 inquires of the scheduler 144 whether the backup operation can commence. The scheduler 144, utilizing the agent 42 of the device 12 and the module 142 of the server 15, determines that a user is logged onto the device 12 and reschedules the backup operation. After a time period such as several days, the scheduler 144 may detect the change in interactive logins for the device 12 and subsequently schedule all subsequent backup operations for the device 12 at times other than 11 p.m.-7 a.m. when a user is typically logged into device 12.

It should be noted that in connection with determining usage of the device 12 and its local resources, the agent 42 may utilize any one of a variety of different techniques. For example, the agent 42 may report regarding whether someone is logged into the device 12, as well as report on other events indicating presence or usage of the device 12. The agent 42 may report on whether a screen saver is active and for how long the screen saver has been active, whether there are tasks executing that have been initiated by the user while logged on during the current session, and the like. If the screen saver has been active, for example, for two hours, the agent 42 may determine that the device 12, or a particular resource of the device 12, is not “in use” even though a user is logged on. As such, the scheduler 144 may determine that the device 12 is not in use due to the inactivity in accordance with the duration of the screen saver and lack of currently executing tasks initiated during the user's current session.

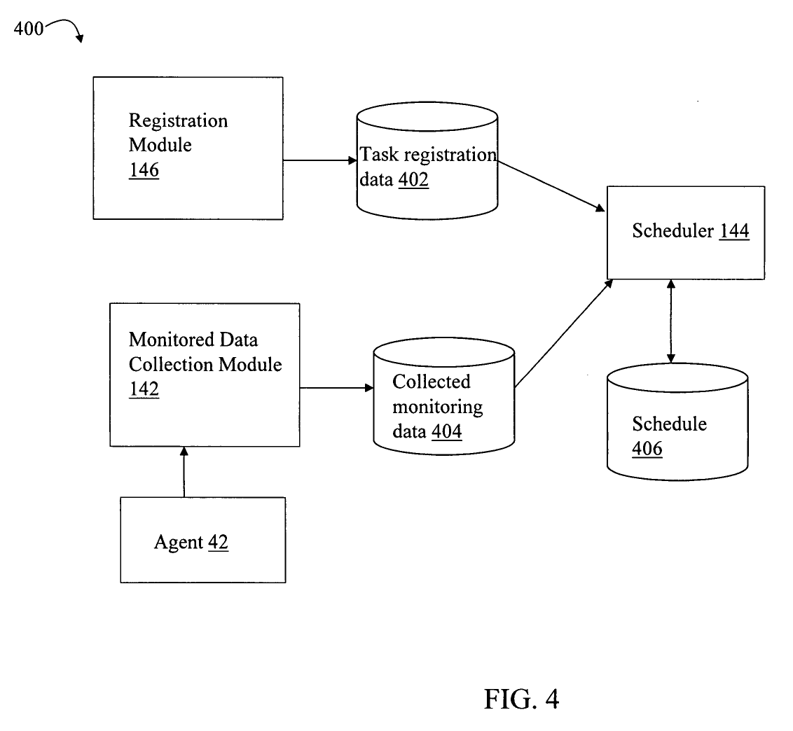

Referring now to FIG. 4, shown is an example illustrating the data flow between components in connection with producing and maintaining a schedule. The example 400 includes the scheduler 144 which receives inputs including the task registration data 402 and collected monitoring data 404. The data 402 may be obtained, for example, using the registration module 146. The data 404 may be obtained, for example, using the module 142 and agents 42 of each device. Each agent 42 may collect data for the device which it is monitoring and may report the data to the module 142. The schedule 406 may be initially determined using data 402. As observed or actual data 404 is collected over time, the scheduler 144 may revise or update the schedule 406.

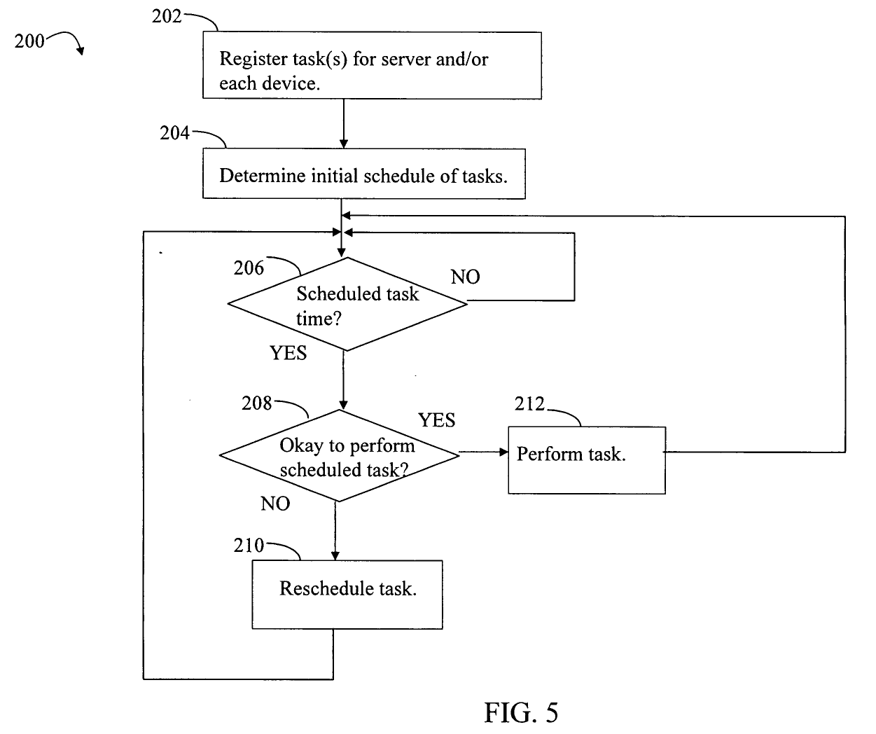

Referring now to FIG. 5, shown is a flowchart of processing steps that may be performed in an embodiment in connection with generating and maintaining a schedule using the techniques herein. The processing steps of 200 summarize processing described elsewhere herein. At step 202, each task for the server and/or devices to be scheduled is registered. At step 204, the scheduler determines an initial schedule of tasks. At step 206, a determination is made as to whether a scheduled task time has occurred. If not, control proceeds to step 206 until a scheduled task time arrives and control proceeds to step 208. As described herein, each device may track a scheduled time for each of its scheduled tasks. At step 208, a determination is made as to whether the scheduled task may be performed. As described herein, when time for a scheduled task arrives, the device may inquire of the scheduler as to whether processing may commence for the scheduled task. Such a determination may be made in accordance with the availability of resources needed by the scheduled task. If a determination is made at step 208 that the scheduled task cannot be performed, control proceeds to step 210 where the task may be rescheduled. Processing proceeds from step 210 to step 206. If step 208 evaluates to yes, the scheduled task is performed and control proceeds to step 206.

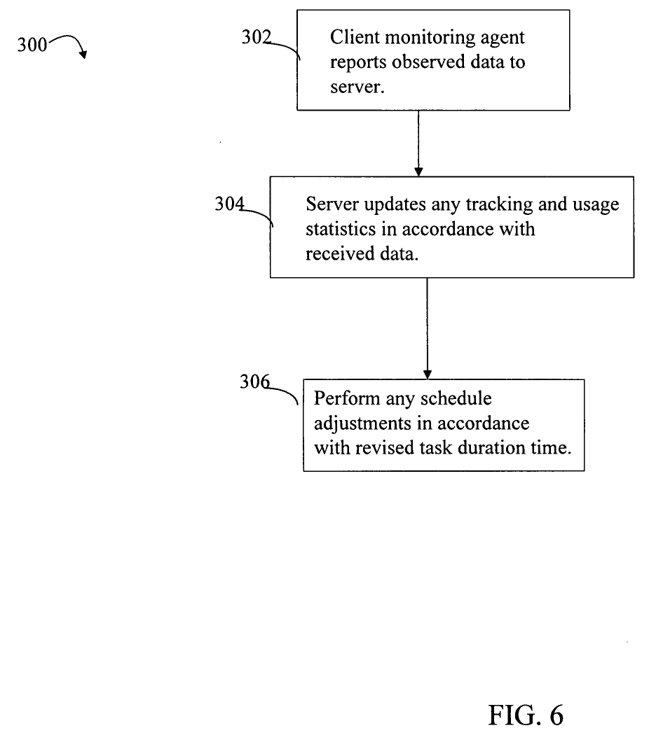

Referring now to FIG. 6, shown is a flowchart of processing steps that may be performed in an embodiment in connection with collecting monitored data. The processing steps of 300 summarize processing described elsewhere herein. At step 302, the client monitoring agent on each device reports collected data to the server. At step 304, the server performs processing to update its collected monitoring information for each device and/or server. Such updating may include revising tracking and usage statistics such as, for example, average duration time for a task, logon activity of a device, and the like. At step 306, the schedule may be updated or revised in accordance with the collected monitoring data and statistics from step 304.

In connection with a current schedule of the server 15, the server 15 may also provide an interface illustrating a graphical view of the current schedule for the different devices and/or server. The view may also indicate the times when the devices are typically in use by an interactive user as determined in accordance with actual or observed data collected.

In one embodiment utilizing the techniques herein, devices 12 and 16 may be personal computers typically in use with interactive logins during specified daytime hours. The techniques herein may be utilized to produce a schedule in which the maintenance tasks, such as backup operations, software updates, and the like, for the devices 12 and 16 are scheduled during non-daytime hours. The scheduled times may be staggered so that, for example, device 12 is not scheduled to have its daily incremental backup operation performed at the same time as the incremental backup operation for device 16. Similarly, the duration times for the various tasks taken into account by the scheduler may adapt to an average duration time in accordance with actual or observed duration times for the tasks over time.

The foregoing provides techniques for tracking usage patterns of each device in connection with determining a collective schedule across all of the devices and/or server tasks. The scheduled task times are determined so as not to conflict with each other and also may be automatically adjusted to adapt to actual usage patterns. Using the techniques herein, the server tracks and collects monitoring data identifying the usage patterns of the devices, server, network and other resources in accordance with scheduled tasks and interactive logon usage of each device. The information regarding usage patterns may include information regarding interactive user logins and tasks performed during the interactive login sessions, and other tasks, such as scheduled maintenance tasks. This information is used by the server in developing and maintaining a schedule of scheduled tasks so that resource contention among the tasks and interactive usage is reduced. Additionally, in connection with scheduling tasks, the techniques herein may utilize priorities associated with the tasks to determine an ordering in which the tasks are scheduled.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for determining a schedule for performing tasks comprising:
registering each of said tasks to be scheduled, said schedule including tasks to be performed for a plurality of devices using at least one shared resource;
determining the schedule for performing said tasks in accordance with resources used by each of said tasks and in accordance with usage patterns of said plurality of devices;
inquiring whether to commence performance of a task at an associated scheduled time in accordance with the schedule;
determining, by a scheduler, whether one or more resources used by said task are available; and
if said determining determines that said one or more resources are not available, rescheduling said task to be performed at another time.

2. The method of claim 1, further comprising:
monitoring activity of device by an agent of said device;
reporting, by said agent, collected data regarding said activity; and
revising said schedule in accordance with said collected data.

3. The method of claim 1, wherein said schedule includes tasks to be performed for a server connected to said plurality of devices.

4. The method of claim 1, wherein the resources include a resource of a server used by said plurality of devices and a network connecting at least a portion of said plurality of devices and said server.

5. The method of claim 1, wherein the resources include at least one resource local to at least one of the plurality of devices.

6. The method of claim 1, wherein said registering a task for one of said plurality of devices includes using an application programming interface including a first parameter identifying the task, a second parameter identifying an expected duration time to perform the task, and a third parameter identifying a scheduling priority of the task, said second and third parameters being optional.

7. The method of claim 6, wherein the application programming interface includes an optional fourth parameter identifying additional scheduling criteria.

8. The method of claim 6, further comprising:
assigning a default value for said second and third parameters if unspecified in connection with performing said registering for a task.

9. The method of claim 1, wherein at least a portion of said devices are computers and said tasks include at least one of: performing a backup operation for each of said computers, performing a software update for each of said computers, and performing a task which uses only local resources of one of said devices.

10. The method of claim 1, wherein the usage patterns include information regarding when a device is used for an interactive login session and when maintenance tasks of the device are performed.

11. The method of claim 10, wherein the schedule schedules maintenance tasks during times when there are no expected interactive login sessions as determined by monitoring activity of said plurality of devices.

12. The method of claim 6, further comprising:
registering a first task using said application programming interface for a first of said plurality of devices;
collecting data regarding activity of said first of said plurality of devices;
determining an average duration time for performing said first task over a period of time; and
adjusting said schedule including said first task in accordance with said average duration time using said average duration time as an updated value for a second parameter associated with said first task.

13. A method for determining a schedule of tasks for a plurality of devices connected to a network and a server, the method comprising:
tracking usage patterns associated with each of said plurality of devices;
determining what resources are used in connection with each of said tasks; and
determining a schedule in accordance with resources consumed by each of said tasks and said usage patterns.

14. The method of claim 13, wherein said resources include at least one shared resource which is utilized by two or more of said tasks.

15. The method of claim 13, wherein said resources include network bandwidth of said network and one or more resources of said server.

16. The method of claim 13, wherein said resources include at least one resource which is local with respect to a first of said plurality of devices and at least one resource which is not local with respect to said first device.

17. The method of claim 13, wherein said tracking includes observing interactive user logins of each of said plurality of devices for an amount of time and scheduling a task for a device at a time when there is no observed interactive user login for said device.

18. The method of claim 13, wherein said step of determining a schedule includes prioritizing said tasks in accordance with a priority associated with each of said tasks, a first task of a first priority scheduled to be performed prior to a second task of another priority lower than said first priority.

19. A computer readable medium comprising code stored thereon for determining a schedule of tasks for a plurality of computers connected to a network and a server, the computer readable medium comprising code for:
tracking usage patterns associated with each of said plurality of computers;
determining resource conflicts in connection with each of said tasks; and
determining a schedule in accordance with resources consumed by each of said tasks and said usage patterns.

20. The computer readable medium of claim 19, wherein said tasks include at least one of: performing a backup operation backing up data from one of said plurality of computers to said server, performing an operating system update for one of said plurality of computers using said server, performing a virus scan of a device of said server, performing defragmentation for a device of said server, performing a virus scan of a device of one of said plurality of computers, performing defragmentation of a device of one of said plurality of computers, performing a disk repair operation for a device of said server, performing a disk repair operation for a device of one of said plurality of computers, and wherein said resources include network resources, server resources and resources of each of said plurality of computers.
